(19) United States
(12) Patent Application Publication
(10) Pub. No.: US 2024/0205664 A1
(43) Pub. Date: Jun. 20, 2024

(54) REDIRECTION OF TRAFFIC INSTANCE IDENTIFICATION IN A 5G SA CORE NETWORK

(71) Applicant: T-Mobile USA, Inc., Bellevue, WA (US)

(72) Inventors: Praveen Singaram Muthukumar, Lawrenceville, NJ (US); Kameswaran Arunachalam, Redmond, WA (US); Kunal Prakash Barawkar, Bothell, WA (US); Aziz Motiwala, Mill Creek, WA (US); Rahul Pal, Bellevue, WA (US); Rushabhkumar Patel, Newcastle, WA (US); Suresh Thanneeru, Redmond, WA (US)

(21) Appl. No.: 18/174,608

(22) Filed: Feb. 25, 2023

Related U.S. Application Data
(60) Provisional application No. 63/387,610, filed on Dec. 15, 2022.

(51) Int. Cl. H04W 8/14; H04W 48/18

(52) U.S. Cl. CPC H04W 8/14; H04W 48/18; H04W 80/045

(57) ABSTRACT

System and methods for efficient user plane function (UPF) selection are described. A mobile device (UE) may transmit a connection request to a 5G core network. The connection request can include an indication that the type of data to be serviced is IPv4-type traffic. The access management function (AMF) receives the request from a base station (e.g., gNodeB) and queries a network function repository function (NRF) for an identification of a session management function (SMF). The selected SMF queries a session management function datastore. If the SMF selected by the NRF is capable of IPV4 traffic, the identification of the SMF is returned to the AMF. If the SMF is not capable of IPV4 traffic, the identification of a capable SMF using the information received in the SMF status datastore is returned to the AMF through a 308 code. The mobile device is thereafter connected to the capable UPF.

### CROSS-REFERENCE TO RELATED APPLICATIONS

This application claims the benefit of U.S. Provisional Application No. 63/387,610 filed Dec. 15, 2022, which is incorporated herein by reference in its entirety.

### BACKGROUND

Since the advent of the Internet, the number of computing devices connected to it has grown exponentially. The primary network or Internet layer protocol in use during the initial growth of the Internet was Internet Protocol version 4 (IPv4). However, as technology has advanced, including cellular technology, the Internet Protocol version 6 (IPv6) was developed and adopted. IPv6 provides, among other enhancements, many more addresses for use by computing devices connected to the Internet than IPv4. However, there are many devices and systems currently in use that are configured to use IPv4. Therefore, network and system operators continue to support IPv4. Efficiently supporting IPv4 devices while concurrently supporting IPv6 devices on current networks may pose a challenge for a network operator.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative wireless communication network environment in which systems and techniques for selecting capable user plane functions may be implemented, in accordance with examples of the disclosure.

FIG. 2 is a diagram of an illustrative signal flow associated with selecting capable user plane functions, in accordance with examples of the disclosure.

FIG. 3 is a flow diagram of an illustrative process for selecting capable user plane functions, in accordance with examples of the disclosure.

FIG. 4 is a schematic diagram of illustrative components in an example user device that is configured for selecting capable user plane functions, in accordance with examples of the disclosure.

FIG. 5 is a schematic diagram of illustrative components in an example computing device that is configured for selecting capable user plane functions, in accordance with examples of the disclosure.

### DETAILED DESCRIPTION

### Overview

This disclosure is directed in part to systems and techniques for redirecting IPv4 traffic requests in a 5G core system from a user equipment (UE) (e.g., smartphone, cell phone, mobile device, wireless communication device, mobile station, etc.). Such advanced networks include networks that support New Radio (NR) networks (e.g., 5G NR networks). However, the disclosed systems and techniques may be applicable in any network or system in which a user device may request and receive access to communicate with network and/or remote devices using any protocol.

In conventional systems, a wireless user device (e.g., mobile telephone, smartphone, user equipment (UE), etc.) may wirelessly communicate with a base station (e.g., gNodeB, eNodeB, NodeB, base transceiver station (BTS), etc.) to request wireless communications services, such as a packet data communication session between the user device and a data network (e.g., the Internet, an IP multimedia system or subsystem (IMS), etc.). A UE's attach request may (explicitly or implicitly) indicate one or more network layer communications protocols that the UE may be configured to support. For example, such a request may be a request for an IPV4-only communications connection, an IPV6-only communications connection, or an IPV4v6 communications connection. A request for an IPv4-only communications connection may indicate that the UE can only support IPv4 communications. A request for an IPV6-only communications connection may indicate that the UE can only support IPV6 communications. A request for an IPV4v6 communications connection (also known as a “dual stack” connection) may indicate that the UE supports both IPv4 and IPV6. Such a UE may prefer to use IPV6 but is able to use IPv4 in the event that an IPv6 connection is not available, for example, because the network does not support IPv6. If the network supports IPv4 and IPV6, the UE may determine to which protocol to use for the requested connection. In various embodiments, an attach request may include a packet data network (PDN) type indicator or value or that indicates an IP version supported and/or requested by the UE (e.g., IPv4, IPv6, IPv4v6). Various operations may be performed by network components, devices, and/or functions to obtain or otherwise establish the requested services for the wireless user device. Such operations may include authenticating the wireless user device and/or a user of the device, authorizing the requested services for the device and/or user, registering the device at the various systems and functions needed to provide the requested services, etc.

For example, a UE may transmit a request for a protocol data unit (PDU) session with a data network to a gNodeB. A PDU session, for example in a 5G network, may be an end-to-end communications session between a device (e.g., the UE) and a data network (e.g., the Internet). The gNodeB may relay or otherwise convey this PDU session request to an access management function (AMF) in the core of the wireless network in which the gNodeB is configured. The AMF may interact with one or more other components to perform the operations needed to establish this session, such as authenticating the device and/or user, registering the UE with the network, etc. In a particular example, the AMF may interact with a session management function (SMF) to establish the session. The SMF may perform various session establishment operations, such as determining and assigning particular functions and/or components to service the session, associating policies for the session, etc. In examples, an important function performed by an SMF may be providing the access information needed by the UE to communicate with a data network using the established session. The SMF provides this information to the AMF for relay to the gNodeB and ultimately to the UE requesting the PDU session. In 5G examples, a message that provides such information may be referred to as a “N1N2MessageTransfer.” These and other messages communicating similar information may be referred to generally herein as a “message transfer” messages.

Components and functions within a network, such as AMFs and SMFs, may vary and may change often due to operational circumstances (e.g., maintenance, load, failures, etc.). Therefore, in various examples, a network may include a repository component or function that is configured to store and provide current addresses and/or other connectivity information for the functions and/or components in the network. In response to receiving a request from a particular function in a network, a repository function may provide a current address (e.g., IP address) for another function to the requesting function. The requesting function may then use that address to communicate with the associated function to perform one or more operations. In 5G examples, such a repository function may be referred to as a network function (NF) repository function (NRF). These and other functions performing similar operations may be referred to generally herein as a “repository functions.” In various embodiments, for example, for load-sharing and/or redundancy purposes, multiple NRFs may be configured in “pools” of NRFs that may be queried by various components and/or functions in (e.g., particular portions of) a core of a wireless network.

In various examples, a particular function may have multiple addresses (e.g., IP addresses) that it may use to communicate with one or more other functions and/or components configured in a network. By using multiple address and/or communications interfaces, a single function or component in a network may interact with multiple other functions and/or components (e.g., substantially simultaneously) and thereby perform various operations more quickly and efficiently. By having multiple address and/or communications interfaces, a single function or component in a network may also have redundant means of communicating with other functions and/or components. For example, if one particular address or interface is no longer reachable for some reason, the function using that address or interface may communicate with other functions and/or components using one of its other addresses or interfaces. In some examples, one or more particular addresses or interfaces configured at a function may be dedicated to one or more particular services or operations, while in other examples, one or more addresses or interfaces configured at a function may be generally available for some or all of the services and/or operations performed at that function. In particular examples, an AMF may be configured with multiple addresses that may be used to communicate with the SMF for various operations, such as PDU session establishment operations.

When requesting an IPV4 PDN type session in conventional 5G core network, a UE requests IPv4 to the gNodeB (GNB) base station. The request from the GNB comes into the AMF and queries the NRF, asking the NRF for all the SMFs based on APN/PDN name. The NRF learns the SMF information when the SMF is published, or made available for use, on the network. NRF provides the AMF the SMF information. The AMF can select any one of the SMFs that were provided by the NRF. The SMFs are associated with one or more User Plane Functions (UPFs). A UPF performs the function of connecting the data coming over the network to the Internet. Each UPF is configured to handle one of at least three types of PDN/PDP requests: IPv4 only traffic: IPv6 only traffic; or IPv4 and IPV6 traffic (dual stack). In instances in which a UPF is selected that only handles IPv6 traffic for an IPV4 request, the request may fail, resulting in a failed connection.

To address the issue of a failed connection attempt when a UPF is selected that does not (or cannot) handle an IPV4 request, the disclosed systems and methods provide for the use of a centralized SMF status database available to the NRF. Rather than selecting an SMF without knowledge of its type capabilities (i.e., IPv4 and/or IPv6), the NRF can access the SMF status database to cause the selection of a UPF that is capable of handling the IPV4 request. The SMF status database can be one or more databases stored in various components of the network. In the presently disclosed subject matter, when the request from the GNB comes into the AMF and queries the NRF, the SMF queries the SMF status database to check that the selected SMF can handle the IPV4 request. If the selected SMF cannot handle the IPv4 request, the SMF sends the instance identification for the one or more SMFs than can handle the IPV4 request back to the AMF. The AMF then selects the SMF capable of handling the IPv4 request.

By facilitating the use of the SMF status database, the systems and methods described herein provide more efficient and accurate handling of IPV4 requests and reduced resource utilization. By providing one or more SMFs capable of handling an IPv4 request at the AMF prior to attempting a connection at the UPF level, the system can not only reduce failed connections, but the UPF resources are only utilized when a correct UPF is selected, increasing the use of valid UPFs, reducing the wasting of resources based on failed attempts.

Illustrative environments, signal flows, and techniques for implementing systems and methods for repository function address blocking are described below. However, the described systems and techniques may be implemented in other environments.

### Illustrative System Architecture

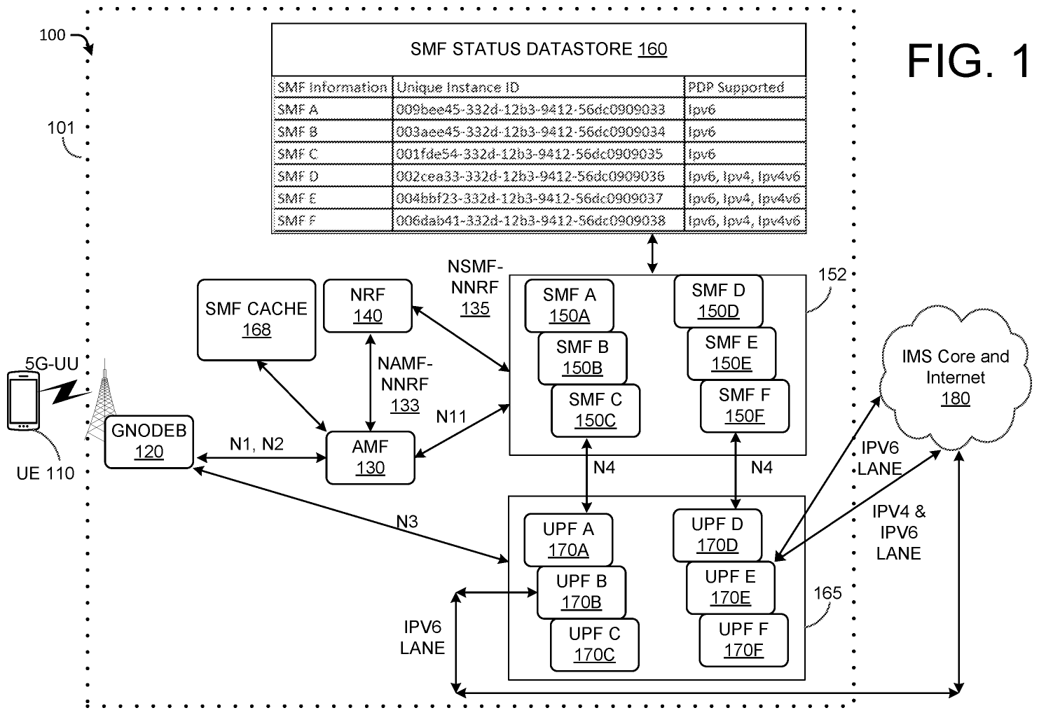

FIG. 1 is a schematic diagram of an illustrative wireless network environment 100 in which the disclosed systems and techniques may be implemented. The environment 100 may include a UE 110 that may wirelessly communicate with an gNodeB 120. While referred to as an “eNodeB” for explanatory purpose herein, the gNodeB 120 may be any type of base station, including, but not limited to, any type of base transceiver station (BTS), NodeB, eNodeB, gNodeB, etc. The gNodeB 120 may communicate with other devices and elements in the core of a wireless communications network 101. The wireless communications network 101 may be any one or more networks that facilitate communications between devices of various types, such as computing device and mobile devices (e.g. UEs). Various connections between devices in the network 101 may be wired, wireless, or a combination thereof. In various embodiments, the wireless communications network 101 may facilitate communications with one or more wireless devices, such as UEs. The wireless communications network 101 may facilitate packet-based communications between such wireless devices and device on the Internet and/or one or more IMSs, such as IMS Core/Internet 180.

In order to facilitate data packet-based communications between the UE 110 and the IMS Core/Internet 180, a user data packet communications session may need to be established. As used herein, such a user data packet communications session may refer to and/or be associated with any user data communications bearer configured to carry user data packets (e.g., user plane traffic) and may be referred to as a data radio bearer. To perform set-up, tear-down, maintenance, and other control operations for a UE and/or an associated user data packet communications session, control communications (e.g., control plane traffic) may be exchanged between network devices and/or UE using signaling radio bearers (that may be referred to simply as “signaling”).

In environment 100, the UE 110 may communicate with the gNodeB 120 to request the establishment of a PDU session (e.g., to communicate with one or more systems at the IMS Core/Internet 180). The gNodeB 120 may relay the request or otherwise transmit a request for the establishment of the PDU session to an AMF 130. In various examples, an AMF 130 may interact with SMFs to allocate the resources required to establish PDU sessions for UEs. Such interactions may include authenticating and authorizing a user and/or user device (e.g., UE), creating contexts for such sessions, determining and applying session policies, establishing user plane resources, etc. Therefore, the AMF 130, based on receiving this request for the establishment of a PDU, i.e., an IPV4-type, session on behalf of the UE 110, may query a NRF 140 for an address (e.g., IP address) for an SMF with which it may interact to establish the requested PDU session. In some examples, the query from the AMF 130 will not include a specific IP type, such as IPv4. In the example illustrated in FIG. 1, the SMFs available to the NRF 140 for selection are SMF A 150A, SMF B 150B, SMF C 150C, SMF D 150D, SMF E 150E, and SMF F 150F.

In the example illustrated in FIG. 1, AMF 130 may exchange SMF discovery communications 133 (Namf-Nnrf), which may be called an SMF address request in some examples, with the NRF 140. In some examples, a wireless communications network may be configured with one or more NRF pools, each of which may include one or more NRFs. In the discovery communication 133, the AMF 130 may provide an identifier of one or more particular SMFs with which it may wish to interact or the AMF 130 may request an SMF address generally. The AMF 130 may or may not specify in the communication 133 a particular service for which the AMF 130 is requesting an address. In the example illustrated in FIG. 1, the AMF 130 identifies that an IPv4 lane is requested. In some examples, the SMFs may be geographically located and configured to provide repository function services to functions and components that are relatively geographically proximate to the UE 110 or the AMF 130. In such examples, there may be one or more pools of SMFs or NRFs provided for a particular geographical area or region. The NRFs or SMFs within each pool may be configured to have synchronized address information for the various devices represented in each NRF or SMF. However, as described herein, such information may become out of sync and/or may not be valid information for component users of such NRF or SMF. Further, an SMF cache 168 may be available to the AMF 130 for a selected or capable SMF, whereby the SMF cache 168 includes identification information of capable SMFs.

In some examples, after receiving the SMF discovery communications 133, the NRF 140 transmits an SMF connection communication 135 (NSMF-NNRF) to one of the SMFs (SMF A 150A, SMF B 150B, SMF C 150C, SMF D 150D, SMF E 150E, and SMF F 150F) in the SMF pool 152. In some examples, when an SMF in the SMF pool 152 is published or made available for use, the NRF 140 receives information that the SMF in the SMF pool 152 is available. Once the particular SMF or group of SMFs (such as the group SMF A 150A/SMF B 150B/SMF C 150C or the group SMF D 150D/SMF E 150E/SMF F 150F) selected by the NRF 140 receives the SMF connection communication 135, the SMF queries an SMF status datastore 160 to determine if the received IPv4 (PDN) request is supported by the SMF or group of SMFs. If the IPV4 request is supportable by the selected SMF, the SMF returns a confirmation message as the SMF connection communication 135. Thereafter, the AMF 130 sends a connection request N11 to the selected SMF. The selected SMF establishes a connection to its coordinating UPF or group of UPFs in the UPF pool 165, which thereafter connects to the IMS Core/Internet 180 through its particular lane. For example, if the SMF A is selected, the SMF A 150 A instantiates a connection N3 from the GNodeB 120 to the UPF A 170 to deliver data from the UE 110 through the IPV6 lane of the UPF A 170A to the IMS Core/Internet 180.

The NRF 140 may select the SMFA 150A. The SMF A 150A queries the SMF status datastore 160 and determines that the SMF A 150A does not handle IPv4 requests. The SMF A 150A, rather than sending a basic error code or trying to establish an N3 connection that may ultimately fail because the UPF A 170A cannot handle IPv4 requests, determines one or more SMFs that can handle an IPv4 request. In this example, the SMF A 150A transmits a 308 code (permanent redirect) to the NRF 140 with the instance identification (ID) of the capable SMF, such as the group of SMFs SMF D 150D/SMF E 150E/SMF F 150F that can, according to the SMF status datastore 160, handle IPv4 requests through their IPv4 & IPV6 lane. Once the N3 connection is made, the capable UPF may handle data transfer between the UE 110 and the IMS Core/Internet 180.

### Illustrative Signal Flows

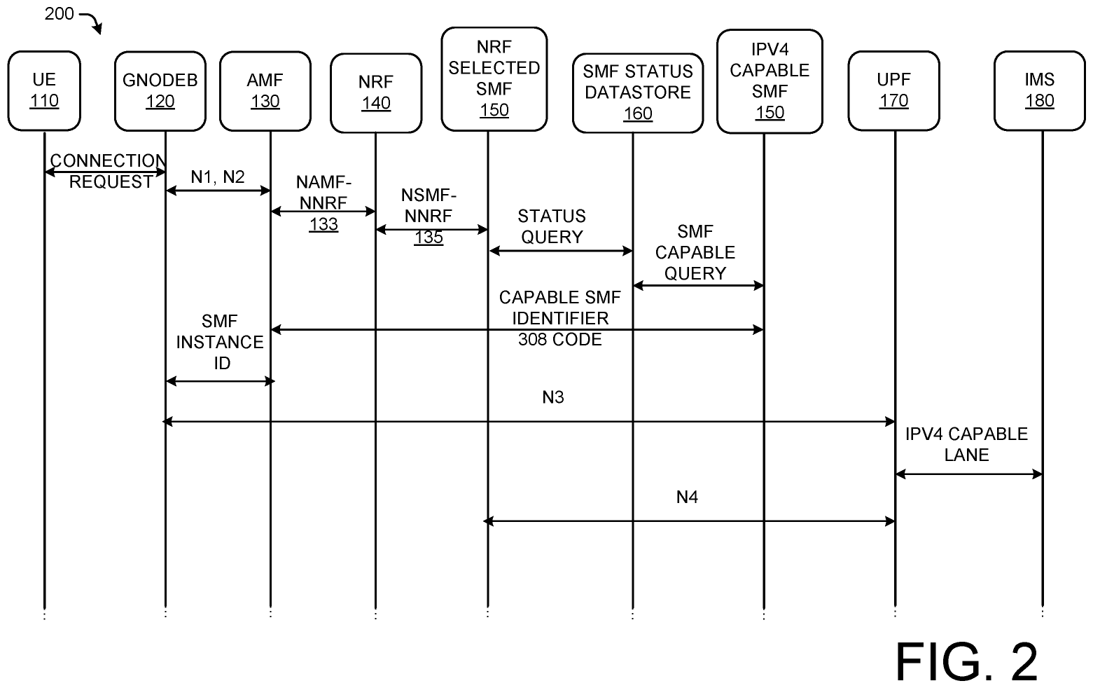

FIG. 2 illustrates an exemplary signal flow 200 of various messages that may be exchanged in one or more of the disclosed systems and techniques for more efficiently performing UPF selection for a UE requesting IPv4 service. Reference may be made in this description of the signal flow 200 to devices, entities, and interfaces illustrated in FIG. 1 and described in regard to that figure. However, the operations, signals, and signal flow illustrated in FIG. 2 and described herein may be implemented in any suitable system and/or with any one or more suitable devices and/or entities. Moreover, any of the operations, signals, and/or entities described in regard to FIG. 2 may be used separately and/or in conjunction with other operations, signals, and/or entities. All such embodiments are contemplated as within the scope of the instant disclosure.

The UE 110 transmits a connection request to the GNodeB 120. The transmit request can include, among other information, a request for an IPv4 lane for IPV4-type traffic. The GNodeB 120 transmits an N1/N2 communication to the AMF 130. In various examples, the AMF 130 may transmit an SMF address request 133 to the NRF 140 requesting an address for an SMF. The SMF address request 133 may include any one or more of an instance identifier of a specific SMF, a specific service, a specific function, a notification of an IPV4-type request, etc. Alternatively, the SMF address request 133 may be more general, requesting an SMF generally or a function to provide particular service (session setup or management), etc.

In response to the SMF address request 133, the NRF 140 selects an SMF 150 through an SMF connection communication 135 (NSMF-NNRF). The selected SMF transmits a status query to the SMF status datastore 160 to check if the selected SMF 150 is capable of IPv4 traffic. If the selected SMF is capable of IPV4 traffic, the NRF 140 transmits the address of the selected SMF to the AMF 130. If the selected SMF is not capable of IPV4 traffic, the selected SMF receives from the SMF status datastore 160 an address of an IPV4 capable SMF 150 through a 308 code (permanent redirect). The 308 code is provided to the AMF 130. The instance ID of the IPV4 capable SMF 150 is transmitted to the GNodeB 120.

Using the instance ID of the IPV4 capable SMF 150, the GNodeB 120 establishes the N3 interface between the GNodeB 120 and the user plane functions. Further, the N4 interface is established between the capable SMF 150 and the corresponding UPF 170 that has an IPV4 lane capable of handling the IPv4-type data requests from the UE 110.

### Illustrative Operations

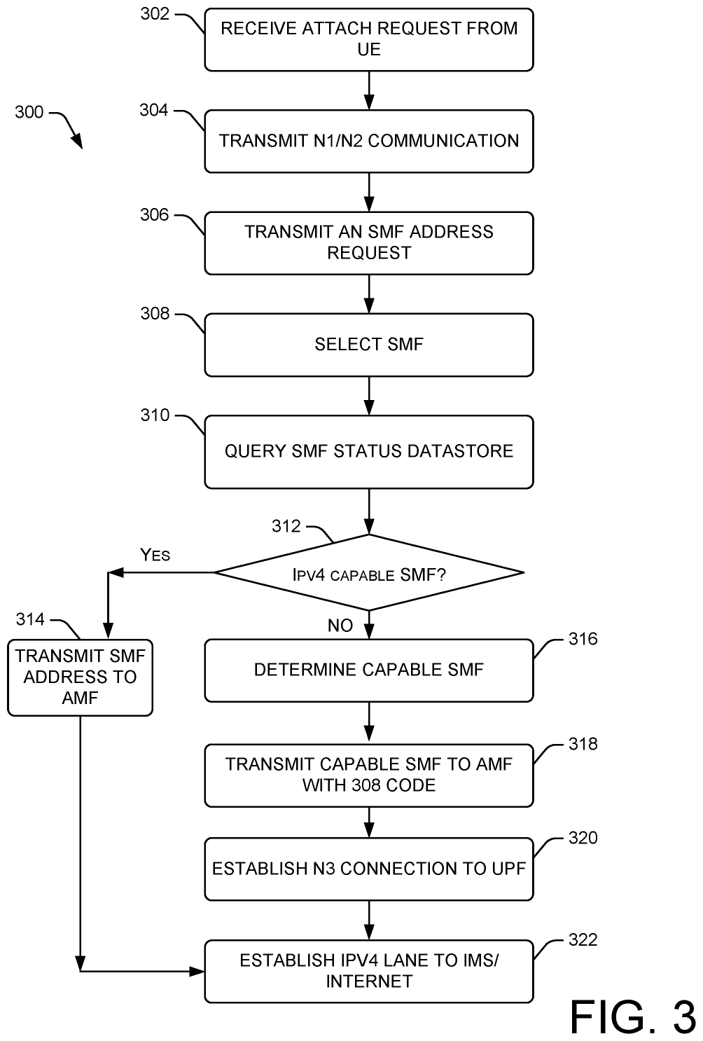

FIG. 3 shows a flow diagram of an illustrative process 300 for selecting a UPF capable of handling IPv4-type data traffic according to the disclosed embodiments. The process 300 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 300 may be described with reference to the wireless network environment 100 of FIG. 1, however other environments may also be used.

At block 302, the gNodeB 120 receives a connection (attach) request from the UE. The transmit request can include, among other information, a request for a PDN type.

At block 304, the GNodeB 120 transmits an N1/N2 communication to the AMF 130.

At block 306, the AMF 130 may transmit an SMF address request 133 to the NRF 140 requesting an address for an SMF. The SMF address request 133 may include any one or more of an identifier of a specific SMF, a specific service, a specific function, a notification of an IPV4-type request, etc. Alternatively, the SMF address request 133 may be more general, requesting an SMF generally or a function to provide particular service (session setup or management), etc.

At block 308, the NRF 140 selects an SMF 150 through an SMF connection communication 135 (NSMF-NNRF).

At block 310, the selected SMF transmits a status query to the SMF status datastore 160 to check if the selected SMF 150 is capable of IPv4 traffic. The SMF status datastore includes a listing of SMFs available for selection and the PDN traffic type capabilities. In the example illustrated in FIG. 1, the capabilities can range from IPv4, IPv6, and a combination of IPV4/IPv6.

At block 312, a determination is made, based on the information in the SMF status datastore, if the selected SMF is capable of IPV4 traffic.

At block 314, if the SMF selected by the NRF is capable of IPV4 traffic, the NRF 140 transmits the address of the selected SMF to the AMF 130.

At block 316, if the selected SMF is not capable of IPV4 traffic, the selected SMF receives from the SMF status datastore 160 an address of an IPV4 capable SMF 150 through a 308 code (permanent redirect) to select a different SMF altogether. A selection of a different instance/service within the same SMF (or group of SMFs) may have the same issue as not being capable of handling IPv4 traffic. Thus, in these examples, the 308 (permanent redirect) is used to reduce or eliminate the probability of a selection of a different instance/service within the same SMF (or SMF group) that are not capable of handling IPv4 traffic.

At block 318, the 308 code is provided to the AMF 130. The instance ID of the IPv4 capable SMF 150 is transmitted to the GNodeB 120.

At block 320, using the instance ID of the IPV4 capable SMF 150, the GNodeB 120 establishes the N3 interface between the GNodeB 120 and the user plane functions.

At block 322, the N4 interface is established between the capable SMF 150 and the corresponding UPF 170 that has an IPV4 lane capable of handling the IPv4-type data requests from the UE 110.

### Example User Equipment

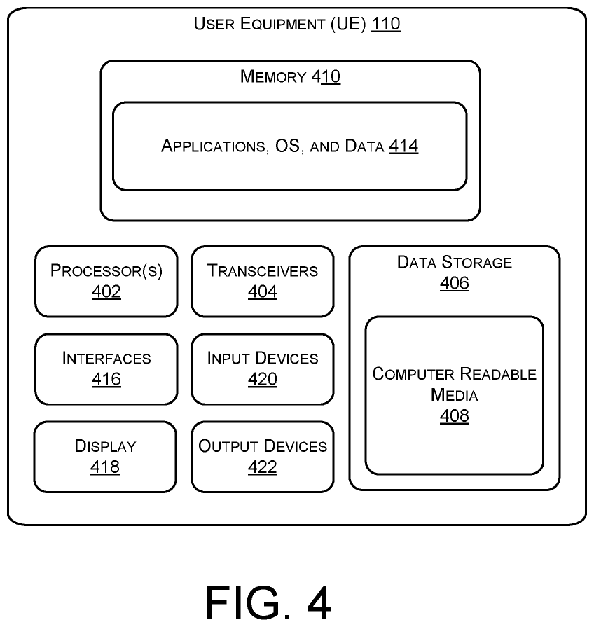

FIG. 4 is an example of a UE, such as UE 110, for use with the systems and methods disclosed herein, in accordance with some examples of the present disclosure. The UE 110 may include one or more processors 402, one or more transmit/receive antennas (e.g., transceivers or transceiver antennas) 404, and a data storage 406. The data storage 406 may include a computer readable media 408 in the form of memory and/or cache. This computer-readable media may include a non-transitory computer-readable media. The processor(s) 402 may be configured to execute instructions, which can be stored in the computer readable media 408 and/or in other computer readable media accessible to the processor(s) 402. In some configurations, the processor(s) 402 is a Central Processing Unit (CPU), a Graphics Processing Unit (GPU), or both CPU and GPU, or any other sort of processing unit. The transceiver antenna(s) 404 can exchange signals with a base station, such as gNodeB 120.

The UE 110 may be configured with a memory 410. The memory 410 may be implemented within, or separate from, the data storage 406 and/or the computer readable media 408. The memory 410 may include any available physical media accessible by a computing device to implement the instructions stored thereon. For example, the memory 410 may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which may be used to store the desired information and which may be accessed by the UE 110.

The memory 410 can store several modules, such as instructions, data stores, and so forth that are configured to execute on the processor(s) 402. In configurations, the memory 410 may also store one or more applications 414 configured to receive and/or provide voice, data and messages (e.g., SMS messages, Multi-Media Message Service (MMS) messages, Instant Messaging (IM) messages, Enhanced Message Service (EMS) messages, etc.) to and/or from another device or component (e.g., the gNodeB 120). The applications 414 may also include one or more operating systems and/or one or more third-party applications that provide additional functionality to the UE 110.

Although not all illustrated in FIG. 4, the UE 110 may also comprise various other components, e.g., a battery, a charging unit, one or more network interfaces 416, an audio interface, a display 418, a keypad or keyboard, and one or more input devices 420, and one or more output devices 422.

### Example Computing Device

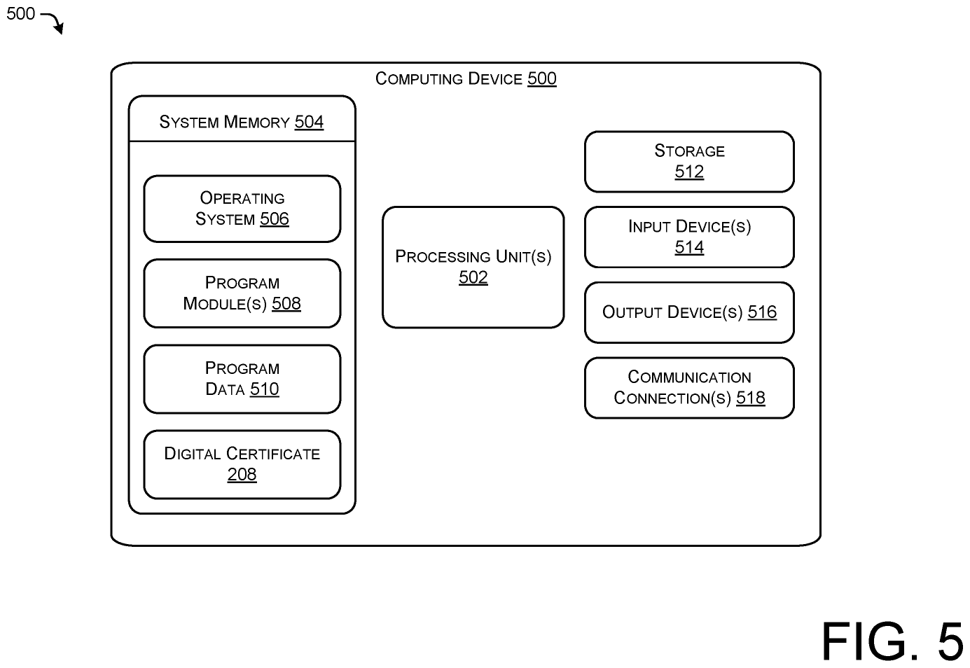

FIG. 5 is an example of a computing device 500 for use with the systems and methods disclosed herein, in accordance with some examples of the present disclosure. The computing device 500 can be used to implement various components of a core network, a base station, and/or any servers, routers, gateways, gateway elements, administrative components, etc. that can be used by a communication provider. One or more computing devices 500 can be used to implement the network 101, for example. One or more computing devices 500 can also be used to implement base stations and other components.

In various embodiments, the computing device 500 can include one or more processing units 502 and system memory 904. Depending on the exact configuration and type of computing device, the system memory 504 can be volatile (such as RAM), nonvolatile (such as ROM, flash memory, etc.) or some combination of the two. The system memory 504 can include an operating system 506, one or more program modules 508, and can include program data 510. The system memory 504 may be secure storage or at least a portion of the system memory 504 can include secure storage. The secure storage can prevent unauthorized access to data stored in the secure storage. For example, data stored in the secure storage can be encrypted or accessed via a security key and/or password.

The computing device 500 can also include additional data storage devices (removable and/or non-removable) such as, for example, magnetic disks, optical disks, or tape. Such additional storage is illustrated in FIG. 5 by storage 512.

Non-transitory computer storage media of the computing device 500 can include volatile and nonvolatile, removable and non-removable media implemented in any method or technology for storage of information, such as computer readable instructions, data structures, program modules, or other data. The system memory 504 and storage 512 are examples of computer readable storage media. Non-transitory computer readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by computing device 500. Any such non-transitory computer readable storage media can be part of the computing device 500.

In various embodiment, any or all of the system memory 504 and storage 512 can store programming instructions which, when executed, implement some or all of the functionality described above as being implemented by one or more systems configured in the environment 100 and/or components of the network 101.

The computing device 500 can also have one or more input devices 514 such as a keyboard, a mouse, a touch-sensitive display, voice input device, etc. The computing device 500 can also have one or more output devices 516 such as a display, speakers, a printer, etc. can also be included. The computing device 500 can also contain one or more communication connections 518 that allow the device to communicate with other computing devices using wired and/or wireless communications.

### Example Clauses

The following paragraphs describe various examples. Any of the examples in this section may be used with any other of the examples in this section and/or any of the other examples or embodiments described herein.

A: All methods, systems, and apparatuses, including all equivalents, disclosed herein.

B: A method, comprising: receiving, at an access management function (AMF) of a 5G core network from a mobile device, a connection request comprising an indication of IPv4 packet data network type; transmitting, from the AMF to a network function repository function (NRF), an identification of a session management function (SMF): selecting, by the NRF, a selected SMF: querying an SMF status datastore for capabilities of the selected SMF: determining that the selected SMF is not capable of handling the IPv4 packet data network type: and transmitting to the AMF an identification of a capable SMF based on SMF status datastore information, the capable SMF having an associated UPF with an IPv4 lane capable of handling the IPv4 packet data network type

C: The method of paragraph B further comprising: determining that the selected SMF is capable of handling the IPV4 packet data network type: and transmitting to the AMF an identification of the selected SMF.

D: The method of any of paragraphs A-C, wherein transmitting to the AMF the identification of the capable SMF comprises using 308 code.

E: The method of any of paragraphs A-D, further comprising instantiating an N3 connection from a base station in communication with the mobile device to the UPF associated with the capable SMF, the UPF having the IPV4 lane capable of handling the IPV4 packet data network type.

F: The method of any of paragraphs A-E, further comprising establishing an N4 interface between the capable SMF and the UPF associated with the capable SMF.

G. The method of any of paragraphs A-F, wherein a packet data network handling the IPv4 packet data comprises one or more of: an Internet: or an IP multimedia subsystem.

H: The method of any of paragraphs A-G, wherein the associated UPF with an IPv4 lane capable of handling the IPv4 packet data network type comprises an IPv4 lane or an IPV4 and IPV6 lane.

I. A session management function, comprising: one or more processors; one or more transceivers: and non-transitory computer-readable media storing computer-executable instructions that, when executed by the one or more processors, cause the one or more processors to perform operations comprising: receiving, at the session management function (SMF), a communication from a network function repository function (NRF) indicating that the SMF is a selected SMF by the NRF, wherein the communication includes a request for IPv4 packet data network type capabilities: querying an SMF status datastore for capabilities of the selected SMF: determining that the selected SMF is not capable of handling the IPv4 packet data network type: and transmitting to an AMF an identification of a capable SMF based on SMF status datastore information, the capable SMF having an associated UPF with an IPv4 lane capable of handling the IPv4 packet data network type.

I. The session management function of paragraph I, further comprising: determining that the selected SMF is capable of handling the IPv4 packet data network type: and transmitting to the AMF an identification of the selected SMF.

J: The session management function of paragraph G or I, wherein transmitting to the AMF the identification of the capable SMF comprises using 308 code.

K: The session management function of any of paragraphs G-J, further comprising instantiating an N3 connection from a base station in communication with a mobile device requesting the IPv4 packet data network type to the UPF associated with the capable SMF, the UPF having the IPV4 lane capable of handling the IPV4 packet data network type.

L: The session management function of any of paragraphs G-K, further comprising establishing an N4 interface between the capable SMF and the UPF associated with the capable SMF.

M: The session management function of any of paragraphs G-L, wherein a packet data network handling the IPv4 packet data comprises one or more of: an Internet: or an IP multimedia subsystem.

N: The session management function of any of paragraphs G-M, wherein the associated UPF with an IPV4 lane capable of handling the IPv4 packet data network type comprises an IPV4 lane or an IPV4 and IPV6 lane.

O: A non-transitory computer-readable media storing computer-executable instructions that, when executed by one or more processors, cause the one or more processors to perform operations comprising: receiving, at an access management function (AMF) of a 5G core network from a mobile device, a connection request comprising an indication of IPv4 packet data network type: transmitting, from the AMF to a network function repository function (NRF), an identification of a session management function (SMF); selecting, by the NRF, a selected SMF: querying an SMF status datastore for capabilities of the selected SMF; determining that the selected SMF is not capable of handling the IPV4 packet data network type: and transmitting to the AMF an identification of a capable SMF based on SMF status datastore information, the capable SMF having an associated UPF with an IPv4 lane capable of handling the IPv4 packet data network type

P: The non-transitory computer-readable media of paragraph O, further comprising: determining that the selected SMF is capable of handling the IPv4 packet data network type: and transmitting to the AMF an identification of the selected SMF.

Q: The non-transitory computer-readable media of any of paragraphs O-P, wherein transmitting to the AMF the identification of the capable SMF comprises using 308 code.

R: The non-transitory computer-readable media of any of paragraphs O-Q, further comprising instantiating an N3 connection from a base station in communication with the mobile device to the UPF associated with the capable SMF, the UPF having the IPv4 lane capable of handling the IPv4 packet data network type:

S: The non-transitory computer-readable media of any of paragraphs O-R, further comprising establishing an N4 interface between the capable SMF and the UPF associated with the capable SMF.

While the example clauses described above are described with respect to one particular implementation, it should be understood that, in the context of this document, the content of the example clauses can also be implemented via a method, device, system, computer-readable medium, and/or another implementation. Additionally, any of the examples A-S can be implemented alone or in combination with any other one or more of the examples A-S.

### CONCLUSION

Depending on the embodiment, certain operations, acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, components, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and components described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “the” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method, comprising:
receiving, at an access management function (AMF) of a 5G core network from a mobile device, a connection request comprising an indication of IPv4 packet data network type;
transmitting, from the AMF to a network function repository function (NRF), an identification of a session management function (SMF);
selecting, by the NRF, a selected SMF;
querying an SMF status datastore for capabilities of the selected SMF;
determining that the selected SMF is not capable of handling the IPv4 packet data network type; and
transmitting to the AMF an identification of a capable SMF based on SMF status datastore information, the capable SMF having an associated UPF with an IPV4 lane capable of handling the IPv4 packet data network type.

2. The method of claim 1, further comprising:
determining that the selected SMF is capable of handling the IPv4 packet data network type; and
transmitting to the AMF an identification of the selected SMF.

3. The method of claim 1, wherein transmitting to the AMF the identification of the capable SMF comprises using 308 code.

4. The method of claim 1, further comprising instantiating an N3 connection from a base station in communication with the mobile device to the UPF associated with the capable SMF, the UPF having the IPv4 lane capable of handling the IPv4 packet data network type.

5. The method of claim 1, further comprising establishing an N4 interface between the capable SMF and the UPF associated with the capable SMF.

6. The method of claim 1, wherein a packet data network handling the IPv4 packet data comprises one or more of:
an Internet; or
an IP multimedia subsystem.

7. The method of claim 1, wherein the associated UPF with an IPV4 lane capable of handling the IPv4 packet data network type comprises an IPV4 lane or an IPV4 and IPV6 lane.

8. A session management function, comprising:
one or more processors;
one or more transceivers; and
non-transitory computer-readable media storing computer-executable instructions that, when executed by the one or more processors, cause the one or more processors to perform operations comprising:
receiving, at the session management function (SMF), a communication from a network function repository function (NRF) indicating that the SMF is a selected SMF by the NRF, wherein the communication includes a request for IPv4 packet data network type capabilities;
querying an SMF status datastore for capabilities of the selected SMF;
determining that the selected SMF is not capable of handling the IPV4 packet data network type; and
transmitting to an AMF an identification of a capable SMF based on SMF status datastore information, the capable SMF having an associated UPF with an IPV4 lane capable of handling the IPv4 packet data network type.

9. The session management function of claim 8, further comprising:
determining that the selected SMF is capable of handling the IPv4 packet data network type; and
transmitting to the AMF an identification of the selected SMF.

10. The session management function of claim 8, wherein transmitting to the AMF the identification of the capable SMF comprises using 308 code.

11. The session management function of claim 8, further comprising instantiating an N3 connection from a base station in communication with a mobile device requesting the IPV4 packet data network type to the UPF associated with the capable SMF, the UPF having the IPv4 lane capable of handling the IPv4 packet data network type.

12. The session management function of claim 8, further comprising establishing an N4 interface between the capable SMF and the UPF associated with the capable SMF.

13. The session management function of claim 8, wherein a packet data network handling the IPv4 packet data comprises one or more of:
an Internet; or
an IP multimedia subsystem.

14. The session management function of claim 8, wherein the associated UPF with an IPv4 lane capable of handling the IPv4 packet data network type comprises an IPv4 lane or an IPV4 and IPv6 lane.

15. A non-transitory computer-readable media storing computer-executable instructions that, when executed by one or more processors, cause the one or more processors to perform operations comprising:
receiving, at an access management function (AMF) of a 5G core network from a mobile device, a connection request comprising an indication of IPv4 packet data network type;
transmitting, from the AMF to a network function repository function (NRF), an identification of a session management function (SMF);
selecting, by the NRF, a selected SMF;
querying an SMF status datastore for capabilities of the selected SMF;
determining that the selected SMF is not capable of handling the IPV4 packet data network type; and
transmitting to the AMF an identification of a capable SMF based on SMF status datastore information, the capable SMF having an associated UPF with an IPv4 lane capable of handling the IPv4 packet data network type.

16. The non-transitory computer-readable media of claim 15, further comprising:
determining that the selected SMF is capable of handling the IPv4 packet data network type; and
transmitting to the AMF an identification of the selected SMF.

17. The non-transitory computer-readable media of claim 15, wherein transmitting to the AMF the identification of the capable SMF comprises using 308 code.

18. The non-transitory computer-readable media of claim 15, further comprising instantiating an N3 connection from a base station in communication with the mobile device to the UPF associated with the capable SMF, the UPF having the IPV4 lane capable of handling the IPv4 packet data network type.

19. The non-transitory computer-readable media of claim 15, further comprising establishing an N4 interface between the capable SMF and the UPF associated with the capable SMF.

20. The non-transitory computer-readable media of claim 15, wherein a packet data network handling the IPv4 packet data comprises one or more of:
an Internet; or
an IP multimedia subsystem.
